(19) United States
(12) Patent Application Publication
(10) Pub. No.: US 2026/0070811 A1
(43) Pub. Date: Mar. 12, 2026

(54) ENABLING INTERNET OF THINGS (IoT) CAPABILITIES IN LEGACY WATER TREATMENT SYSTEMS

(71) Applicant: Evoqua Water Technologies LLC, Pittsburgh, PA (US)

(72) Inventors: Scott Branum, Birmingham, AL (US); Christine Martynuk, Ashburnham, MA (US)

(21) Appl. No.: 19/109,646

(22) PCT Filed: Sep. 8, 2023
(86) PCT No.: PCT/US2023/032295

§ 371 Date: Mar. 7, 2025

Related U.S. Application Data
(60) Provisional application No. 63/404,984, filed on Sep. 9, 2022.

(51) Int. Cl. C02F 1/00; C02F 1/44; G06Q 50/06; G16Y 10/35; G16Y 40/40

(52) U.S. Cl. CPC C02F 1/008; C02F 1/441; G16Y 10/35; G16Y 40/40; C02F 2209/008; C02F 2209/02; C02F 2209/03; C02F 2209/05; C02F 2209/40; C02F 2209/42; C02F 2303/14; G06Q 50/06

(57) ABSTRACT

Methods of monitoring water treatment systems by obtaining measurements of water treatment system parameters and transmitting the measurements to a local controller and cloud-based platform are disclosed. Systems for monitoring water treatment systems are also provided. The systems include at least one sensor positioned to measure a parameter of the water treatment system, a treatment module operably connected to the at least one sensor, and a local controller operably connected to the treatment module and a cloud-based platform. Methods of retrofitting water treatment systems by providing the treatment module and local controller are also disclosed.

### CROSS-REFERENCE TO RELATED APPLICATIONS

This application is a national phase application of International Patent Application PCT/US2023/032295 filed Sep. 8, 2023, which claims priority under 35 U.S.C. § 119(e) to U.S. Provisional Application Ser. No. 63/404,984 filed Sep. 9, 2022, both titled “ENABLING INTERNET OF THINGS (IoT) CAPABILITIES IN LEGACY WATER TREATMENT SYSTEMS”, and both incorporated herein by reference in their entirety for all purposes.

### FIELD OF TECHNOLOGY

Aspects and embodiments disclosed herein are generally related to water treatment systems and, more specifically, to water treatment systems capable of collecting data and transmitting notifications to a user.

### SUMMARY

In accordance with one aspect, there is provided a method of monitoring a water treatment system. The method may comprise obtaining at least one measurement, each measurement obtained from a respective sensor positioned to measure a respective parameter of the water treatment system. The method may comprise transmitting the at least one measurement to a treatment module. The treatment module may be configured to produce an aggregated signal. The method may comprise transmitting the aggregated signal to a local controller. The local controller may be configured to determine whether any measurement is outside a predetermined range. The method may comprise, responsive to the at least one measurement being outside the predetermined range, generating a first communication to notify a user that the measurement is outside the predetermined range. The method may comprise transmitting the aggregated signal to a cloud-based platform.

In some embodiments, determining whether any measurement is outside the predetermined range comprises decoding the aggregated signal to obtain a plurality of signal values and comparing each signal value to at least one respective reference value defining the predetermined range to determine whether any signal value is outside the predetermined range.

The method may further comprise responsive to the at least one measurement being outside the predetermined range, generating in the first communication a recommendation to perform maintenance on the water treatment system.

The method may further comprise providing the at least one reference value defining the predetermined range to the local controller.

The method may comprise transmitting the aggregated signal to the cloud-based platform to determine whether the water treatment system is trending to an alarm state and generating a second communication to notify the user that the water treatment system is trending to the alarm state.

In some embodiments, determining whether the water treatment system is trending to the alarm state comprises decoding the aggregated signal to obtain a plurality of signal values, comparing each signal value to at least one respective reference value defining a target range; if at least one signal value is outside the target range, providing the plurality of signal values to a transformation function trained with historical data and performing a calculation on the transformation function to obtain a plurality of predictive signal values; and comparing the plurality of predictive signal values to at least one respective reference value defining the predetermined range to determine whether any predictive signal value is outside the predetermined range; wherein the water treatment system is trending to an alarm state if at least one predictive signal value is outside the predetermined range.

In some embodiments, the water treatment system is determined to be trending to the alarm state if only one predictive signal value is outside the predetermined range.

The method may comprise providing the plurality of signal values and concurrent data to the transformation function to obtain the plurality of predictive signal values.

The method may comprise providing the at least one reference value defining the target range to the cloud-based platform, and providing the at least one reference value defining the predetermined range to the cloud-based platform.

The method may further comprise responsive to determining that the water treatment system is trending to the alarm state, generating in the second communication a recommendation to perform maintenance on the water treatment system.

In accordance with another aspect, there is provided a method of retrofitting a water treatment system. The method may comprise providing a treatment module operably connectable to at least one sensor positioned to measure a parameter of the water treatment system. The method may comprise operably connecting the treatment module to the at least one sensor. The method may comprise providing a local controller operably connectable to the treatment module and operably connectable to a cloud-based platform. The method may comprise operably connecting the local controller to the treatment module and the cloud-based platform.

In some embodiments, responsive to the local controller receiving the measurement of the parameter, the local controller is programmed to determine whether the measurement is outside a predetermined range and generate a first communication to notify a user that the measurement is outside the predetermined range.

The method may further comprise providing one or more value for the predetermined range to the local controller.

The method may further comprise assessing the water treatment system to determine target measurable parameters and selecting the at least one sensor.

In some embodiments, the treatment module is operably connectable to a plurality of sensors, each sensor configured to measure a respective parameter of the water treatment system. The method may comprise operably connecting the treatment module to each sensor.

The method may comprise providing more than one treatment module selected from a pretreatment module, a processing module, a polishing module, and a distribution module. The method may further comprise operably connecting each treatment module to a respective plurality of sensors.

In some embodiments, responsive to the local controller transmitting a plurality of measurements, each measurement of a respective parameter, to a cloud application via the cloud-based platform, the cloud application is programmed to determine whether the water treatment system is trending to an alarm state and generate a second communication to notify a user that the water treatment system is trending to the alarm state.

The method may further comprise providing one or more value for a plurality of predetermined ranges to the cloud application, each predetermined range associated with a respective measurement.

The method may further comprise providing the at least one sensor.

The method may further comprise installing the at least one sensor within the water treatment system.

In accordance with another aspect, there is provided a system for monitoring a water treatment system. The system may comprise at least one sensor positioned to measure a parameter of the water treatment system. The system may comprise a treatment module operably connected to the at least one sensor. The system may comprise a local controller operably connected to the treatment module and operably connectable to a cloud-based platform, the local controller programmed to determine whether a measurement of the parameter is outside a predetermined range and generate a first communication to notify a user that the measurement is outside the predetermined range.

The system may comprise a plurality of sensors operably connected to the treatment module, each sensor configured to measure a respective parameter of the water treatment system.

In some embodiments, each sensor is selected from a flow meter, pressure meter, conductivity meter, resistivity meter, temperature sensor, composition sensor, pH meter, light meter, and a tank level sensor.

The system may comprise a plurality of treatment modules selected from a pretreatment module, a processing module, a polishing module, and a distribution module.

In some embodiments, the treatment module comprises at least one input signal module operably connected to the plurality of sensors and a data aggregator operably connected to the at least one input signal module and the local controller.

In some embodiments, the data aggregator is programmed to receive a plurality of input signals from the input signal module, each input signal comprising a respective measurement of each parameter, the data aggregator further being programmed to produce an aggregated signal from the plurality of input signals and transmit the aggregated signal to the local controller.

In some embodiments, the at least one sensor is configured to transmit a digital signal to the input signal module.

In some embodiments, the at least one sensor is configured to transmit an analog signal to the input signal module.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a box diagram of a system for monitoring a water treatment system, according to one embodiment;

FIG. 2 is a box diagram of another system for monitoring a water treatment system, according to one embodiment;

FIG. 3 is a schematic diagram of a system for monitoring a water treatment system, according to one embodiment;

FIG. 4 is a flow diagram of a method for monitoring a water treatment system, according to one embodiment; and

FIG. 5 is a flow diagram of a method for retrofitting a water treatment system, according to one embodiment.

### DETAILED DESCRIPTION

The disclosure relates to systems and methods for monitoring water treatment systems from a remote location. The disclosure also provides methods to retrofit existing water treatment systems to allow monitoring from a remote location. Water treatment systems, as used herein, may encompass any system for processing water, in particular, for removal of contaminants or undesired constituents. While the disclosure generally refers to municipal and industrial water treatment systems, other systems for water treatment are within the scope of the disclosure.

Many existing water treatment systems are not equipped for remote monitoring and/or control. While these systems may contain various sensor devices (such as, for example, flow meters, conductivity and resistivity meters, temperature sensors, pH sensors, hydrogen sulfide sensors, or other scientific instruments) for monitoring the condition of the water treatment system, these sensors are not typically equipped for remote monitoring. Thus, it would be necessary for technicians to physically visit remote sites to gather data from the sensors. Completing multiple site visits in numerous locations is a challenging, labor intensive, and expensive task. Regularly scheduled maintenance may be needed to ensure accurate and reliable data.

Even those water treatment systems that do include remote monitoring capabilities and automated alarms to indicate a potential fault or failure do not typically provide predictive analytics to preemptively identify sources of future faults or failures. Furthermore, such remote monitoring capabilities are often implemented during new water treatment system installations, in which the digital water management system is formed as an integral part of the design of the water treatment system. Many water treatment systems exist within their current operating lifetimes that do not have such capabilities. Thus, there is a desire to design and integrate similar remote monitoring functionality in existing water treatment systems.

Methods of improving by, for example retrofitting, existing water treatment systems and incorporating remote monitoring systems capable of being integrated within existing water treatment systems are provided herein. The remote monitoring system may be designed to collect data and monitor various meters, sensors, and scientific instruments positioned in remote locations of the water treatment system. The remote monitoring system may be designed to notify a user if any of the collected data is outside a predetermined range. In certain embodiments, the remote monitoring system may be designed to predict future operation of the water treatment system based on historically collected data, and optionally on concurrent data retrieved from a public database, such as environmental or situational data for factors which might affect the water treatment system operation. The concurrent public data may be associated with, for example, geographic location, season, weather predictions, and others. Thus, the remote monitoring system may be designed to notify a user of a future fault or failure within the system, allowing time to schedule a maintenance call.

The remote monitoring system disclosed herein may comprise a treatment module. The treatment module may be operably connectable to at least one sensor of the water treatment system. In use, the treatment module may be operably connected to the at least one sensor and configured to receive a measurement of a parameter of the water treatment system from the at least one sensor. The treatment module may be capable of receiving the measurement and transmitting a signal encoding the measurement to a controller or cloud-based platform, enabling remote communication with the water treatment system sensor.

The monitoring system disclosed herein may be used in methods of monitoring an existing water treatment system. The monitoring methods may comprise obtaining a plurality of measurements, each measurement obtained from a respective sensor positioned to measure a respective parameter of the water treatment system. Exemplary parameters include flow rate, flow totalization, pressure, conductivity, resistivity, temperature, composition (for example, water and gas or headspace composition), pH, light absorbance, light intensity, tank level (for example, fill volume or percentage), and other water treatment system parameters. Each parameter may be measured at one or more points within the water treatment system.

The methods may comprise transmitting the plurality of measurements to the treatment module to produce an aggregated signal. The plurality of measurements may be transmitted to a data aggregator. Optionally, the plurality of measurements may be transmitted to an input signal module upstream from the data aggregator. Multiple input signal modules may each receive a plurality of measurements and transmit one or more input signal to a data aggregator. Thus, a plurality of measurements may be converted into an aggregated signal for efficient transmission and processing.

In some embodiments, the systems and methods may include one-way or unidirectional remote communication with the sensor, for example, the treatment module may transmit the signal in one direction from the sensor to a controller or platform. In other embodiments, the systems and methods disclosed herein may include two-way or bi-directional communication with the sensor, for example, the treatment module may transmit the signal from the sensor to a controller or platform and also transmit a signal from a controller or platform to the sensor. The signal transmitted from the controller or platform to the sensor may include instructions to restart, re-measure, calibrate or recalibrate the sensor, timing intervals for the measurements, and other sensor-specific instructions.

The signal transmitted from the sensor to the controller or module may include measurement information. In addition to transmitting the measurement information to the controller or platform, the systems and methods may also include transmitting useful sensor information, such as a power status (e.g., battery life or power source) of the sensor, timing since the last maintenance or calibration of the sensor, lifetime of the sensor in use, and other sensor-specific information. The treatment module may be capable of transmitting to the sensor a signal encoding an update, such as a software update.

Thus, in some embodiments, the treatment module may be connectable to more than one sensor. The system may comprise a plurality of sensors operably connected to the treatment module. Each sensor may be configured to measure a respective parameter of the water treatment system. Exemplary sensors include flow meters, pressure meters, conductivity meters, resistivity meters, temperature sensors, composition sensors (for example, water and gas or headspace composition sensors), pH meters, light meters, tank level sensors, and other sensors configured and positioned to measure parameters of the water treatment system.

In some embodiments, in particular when the system includes more than one sensor, the treatment module may be capable of receiving a plurality of input signals encoding a plurality of measurement values and generating an aggregated signal. The plurality of measurement values may be obtained by a plurality of sensors or the same sensor. Thus, in some embodiments, the treatment module may comprise a data aggregator. The data aggregator may be operably connected to the plurality of sensors. Each sensor may transmit at least one input signal to the data aggregator. The aggregator may be programmed to receive the plurality of input signals, each input signal encoding a respective measurement value of a parameter, and produce an aggregated signal from the plurality of input signals. The data aggregation function of the treatment module may enable robust scale up of the monitoring system.

In some embodiments, the treatment module may further comprise at least one input signal module operably connected between the plurality of sensors and the data aggregator. The input signal module may receive input signals directly from each sensor and transmit the input signals to the data aggregator. Due to the limited input ports of a data aggregator, a larger number of signals may be transmitted by incorporating one or more input signal modules. Thus, the data aggregator may be capable of receiving input signals from at least one input signal module, and optionally also directly from at least one sensor, to produce the aggregated signal. Additional input signal modules may be added with the addition of new sensors to scale up the monitoring system.

In some embodiments, the remote monitoring system operably connected to the water treatment system can aggregate data for transmission to a control or monitoring center, e.g. to a programmable logic controller (PLC), through a local area network or ethernet. In some embodiments, data from the one or more sensors may be aggregated in a data aggregator and the aggregated signal may then be sent to a PLC. In some embodiments, a plurality of treatment modules each with one or more data aggregators operably connected respectively to a subsystem of a water treatment system can send and receive signals to and from a central controller or monitoring center.

The input signal module may comprise at least two input ports, for example, 2, 4, 6, 8, 10, 12, 14, 16, 18, 20, or more input ports. The input ports may be digital, analog, or a combination of both. The input signal module may comprise at least one output port, for example, 1, 2, 3, 4, 5, 6, 7, 8, 9, 10, or more output ports. The output ports may generally be digital. In some embodiments, the input signal module may be a digital signal converter, capable of converting an analog input signal into a digital output signal. One exemplary input signal module is an IO-Link hub. IO-Link hub is an input connector for multiple sensors that reduces wiring complexity by eliminating the need to use conventional parallel wiring of each sensor to the controller. Data communication and processing including aggregation, deaggregation, or decoding may be effected under IEC 61131-9.

The disclosure refers generally to IO-Link components. IO-Link is a point-to-point communication system used to connect sensors to a dashboard, remote control, and/or automation system. There are numerous vendors who provide IO-Link-enabled technology, including, for example, Ifm Efector, Inc. (Malvern, PA) and Keyence Corporation of America (Itasca, IL). IO-Link hubs may enable data collection from digital and analog sensors, without complex PLC programming or complicated analog 4-20 mA scaling. Thus, IO-Link hubs and other IO-Link devices described herein, may be used with existing analog sensors. It should be understood that other communication technology may be used in accordance with the disclosure.

The data aggregator may comprise at least one input port, for example, 1, 2, 3, 4, 5, 6, 7, 8, 9, 10, or more input ports. The data aggregator may comprise at least one output port, for example, 1, 2, 3, 4, 5, 6, 7, 8, 9, 10, or more output ports. One exemplary data aggregator is an IO-Link master. The IO-Link master is a gateway for the connection of a plurality of devices including sensors and input modules, such as the IO-Link hub. The IO-Link master aggregates data from the IO-Link hub and/or directly connected sensors, and communicates the aggregated data as an aggregated signal to a controller. The IO-Link master may be used to replace a traditional analog input card and allow for a digital communication path between sensors and a local controller.

In some embodiments, the system may comprise a plurality of treatment modules. Each treatment module may be connectable to one or more sensor. The treatment modules may be selected from a pretreatment module, a processing module, a polishing module, and a distribution module. In general, water treatment systems may be subdivided into a plurality of subsystems, including two or more of pretreatment, processing, polishing, and distribution. Each subsystem may be provided with an associated treatment module. The treatment module may be positioned in proximity to the one or more sensor of the subsystem. For example, the treatment module may be positioned in proximity to one or more unit operation of the system. The treatment module may be connectable to the one or more sensor of the subsystem by a wired connection. The treatment module may be connectable to one or more sensor of the subsystem by a wireless connection, for example, a short-range wireless network, such as Bluetooth®, Wi-Fi®, ZigBee, LoRaWAN®, or any local area network (LAN) or personal area network (PAN).

A first subsystem is the pretreatment subsystem. The pretreatment subsystem may include one or more unit operation to remove gross or suspended solids from the water being treated. The pretreatment subsystem may receive and pretreat wastewater to produce pretreated water. The pretreatment subsystem may comprise, for example, a filter mesh or filtration module. The pretreatment subsystem may comprise a primary solids-liquid separation unit, such as clarifier, thickener, or settler. In some embodiments, the pretreatment subsystem may comprise a source of a coagulant and/or a flocculant upstream from the primary solids-liquid separation unit.

A second subsystem is the processing subsystem. The processing subsystem may be fluidly connected to the pretreatment subsystem. The processing subsystem may include one or more treatment unit operations for the pretreated water. The processing subsystem may receive and treat pretreated water to produce treated water. The processing subsystem may comprise, for example, a biological reactor, a ballasted flocculation reactor, a dissolved air flotation unit, or other water treatment unit.

A third subsystem is the polishing subsystem. The polishing subsystem may be fluidly connected to the processing subsystem. The polishing subsystem may include one or more post-treating unit operation for the treated water. The polishing subsystem may receive and polish treated water to produce polished water. In some embodiments, the polishing subsystem may comprise a secondary solids-liquid separation unit, such as a clarifier, thickener, or settler. In other embodiments, the polishing subsystem may comprise, for example, reverse osmosis (RO), electrochemical treatment, membrane filtration, or ultraviolet (UV) treatment. In some embodiments, the polishing subsystem may comprise a source of chlorine or other disinfectant.

A fourth subsystem is the distribution subsystem. The distribution subsystem may be fluidly connected to the polishing subsystem. The distribution subsystem may include a storage and/or distribution network for the polished water. The distribution subsystem may receive and store or distribute polished water. In certain embodiments, the distribution subsystem may distribute polished water to a point of use.

The disclosure provides methods of retrofitting existing water treatment systems with remote monitoring capabilities. Retrofitting an existing water treatment system may include providing a treatment module and operably connecting the treatment module to at least one sensor. The sensor may be an existing sensor of the water treatment system, as previously described. The treatment module may be connectable to digital or analog sensors. Thus, existing digital and analog sensors which typically require manual readings may be connectable to a treatment module to enable remote readings.

In some embodiments, the treatment module is operably connectable to a plurality of sensors. Retrofitting the water treatment system may comprise operably connecting the treatment module to each sensor. Furthermore, in some embodiments, retrofitting the system may comprise providing a plurality of treatment modules, for example, selected from the pretreatment module, processing module, polishing module, and distribution module. The method may further comprise operably connecting each treatment module to a respective plurality of sensors.

In some embodiments, retrofitting a water treatment system may include providing at least one sensor and positioning the sensor within the water treatment system, for example, installing the sensor within the water treatment system. The provided sensor may replace an existing sensor. In other embodiments, the provided sensor may be selected to measure an additional target parameter. When providing a plurality of sensors, each sensor may be positioned to measure a respective parameter of the water treatment system. There is a desire to update existing water treatment systems with newer or additional sensors to gather and collect more operational data. Newer sensor technologies that transmit digital signals may be more reliable and accurate than analog sensors. Thus, in accordance with certain embodiments, the method may comprise replacing existing analog sensors with digital sensors. In accordance with certain embodiments, the method may comprise providing any new sensors as digital sensors.

In some embodiments, the sensor may be a unidirectional sensor. The sensor may be capable of measuring a parameter and transmitting the measurement to the treatment module. In addition to transmitting the measurement information to the treatment module, the sensor may also be capable of transmitting useful sensor information, such as a power status (e.g., battery life or power source) of the sensor, timing since the last maintenance or calibration of the sensor, lifetime of the sensor in use, and other sensor-specific information.

In some embodiments, the sensor may be a bi-directional sensor. The sensor may be capable of transmitting signals and also receiving a signal from the treatment module. The sensor may be capable of receiving a signal encoding an update, such as a software update. The sensor may be capable of receiving a signal providing instructions to restart, re-measure, calibrate or recalibrate the sensor, timing intervals for the measurements, and other sensor-specific instructions.

One exemplary digital sensor is an IO-Link sensor. IO-Link sensors are bi-directional sensors that transmit a 100% digital signal. The IO-Link sensors may also provide additional data not normally available in a sensor without PLC logic. For example, an IO-Link flow meter may be capable of providing flow totalization as well as instantaneous flow readings. Flow meters utilized in the systems disclosed herein (whether IO-Link flow meters or otherwise) may be clamp-on meters, eliminating the need to cut into a line for installation. Additionally, certain sensors such as pressure and conductivity meters (whether IO-Link meters or otherwise), may be provided with an NPT threaded connection, allowing for simple replacement of existing sensors with newer technology.

In some embodiments, the methods may include assessing the water treatment system. The assessment may be performed to determine target measurable parameters, for example, for system monitoring. The methods may include selecting appropriate sensors, for example, responsive to the assessment, to measure those target measurable parameters. Thus, in accordance with certain embodiments, the methods may include designing the remote monitoring system based on the performance of the existing water treatment system.

The remote monitoring system may comprise a local controller operably connected to the treatment module and operably connectable to a cloud-based platform. In use, the local controller may be operably connected to the cloud-based platform. The local controller may enable remote communication with the water treatment system sensors via the cloud-based platform. A cloud application accessible on a remote computing or mobile device may provide a dashboard for communication with the sensors via the local controller and treatment module. Thus, the methods of monitoring a water treatment system disclosed herein may comprise transmitting the aggregated signal from the treatment module to the local controller. The methods may also comprise transmitting the aggregated signal to the cloud-based platform, for example, from the local controller to the cloud-based platform.

The local controller may be connectable to the treatment module by a wired connection. The local controller may be connectable to the treatment module by a wireless connection, for example, a short-range wireless network, such as Bluetooth®, Wi-Fi®, ZigBee, LoRaWAN®, or any local area network (LAN) or personal area network (PAN). The local controller, being positioned in the field, for example, within or in proximity to the water treatment system, may be connectable to the cloud-based platform by a wireless data connection, such as the Global System for Mobile Communications (GSM) cellular telephone network, Universal Mobile Telecommunications System (UMTS), or to a provider network (the local controller may be connected to a modem connectable to a provider network by a wired connection, such as ethernet, or a wireless connection, such as Wi-Fi® or other LAN). Additionally, the local controller may be equipped to utilize any appropriate GSM or UMTS broadband cellular network technology, such as, 3G, 4G, 5G, LTE, or others. Thus, in some embodiments, the local controller may comprise a SIM card, chipset, and/or modem for internet connectivity.

In certain embodiments, the local controller may be equipped to both connect via the cellular telephone network and a provider network. The user may select which network to use for the local controller connection. The local controller may be connected to a preferred network, such as a provider network, and be programmed to automatically connect to the alternate network, such as the cellular telephone network, upon losing connectivity with the preferred network. Thus, in some embodiments, the local controller may connect to the cellular telephone network as a backup network upon losing connectivity to the provider network, to maintain connectivity with the cloud-based platform.

The local controller may comprise a processor and, optionally, a memory storage device. The processor may be configured to receive and transmit the aggregated signal between the treatment module and the cloud-based platform. In some embodiments, the processor may be configured to decode the aggregated signal to obtain a plurality of signal values corresponding to the measurements obtained by the water treatment system sensors. The memory storage device may store at least some aggregated signals and/or at least some of the plurality of signal values. In other embodiments, the processor may be operably connected to a cloud-based memory storage device or the processor may utilize a combination of local memory storage on a memory storage device and cloud-based memory storage.

In some embodiments, the memory storage may store historical system operating data, such as daily, weekly, monthly, or lifetime values of the parameters measured by the sensors. Exemplary historical operating data may include daily or lifetime water consumption totalization, average daily or lifetime contaminant levels in incoming water, average daily or lifetime contaminant levels in treated or polished water, and others. In some embodiments, the memory storage may store acceptable operating values, such as predetermined values, threshold ranges, and target values for the parameters measured by the sensors. Exemplary acceptable operating values include threshold flow rates and/or water retention times, target contaminant levels in treated polished water and tolerance values, and others. In some embodiments, the memory storage may store system operating instructions.

Thus, in certain embodiments, the local controller may provide edge computing, such as edge alarming. The methods of monitoring a water treatment system may comprise determining whether any measurement is outside a predetermined range.

In some embodiments, determining whether any measurement is outside the predetermined range comprises decoding the aggregated signal to obtain a plurality of signal values and comparing each signal value to at least one respective reference value or within an acceptable tolerance of the reference value or within an acceptable or predetermined range defining the predetermined range to determine whether any signal value is outside the predetermined range. For example, the local controller may be programmed to determine whether a measurement of the parameter is outside the predetermined range. In particular, the local controller may be programmed to decode the aggregated signal to obtain a plurality of signal values referring to the measurement values. The local controller may be programmed to compare each signal value to at least one respective reference value defining the predetermined range for acceptable operation of the system.

The predetermined range of the measured parameter selected for acceptable operation of the water treatment system may be based on an acceptable product water quality or other considerations, such as energy consumption, unit operation or water storage volumes, and safe operating standards of system components. The user may select upper and lower limits for the predetermined range. In other embodiments, the user may select a target value for each measured parameter. The upper and lower limits of the predetermined range may be selected based on an acceptable tolerance for the value of the measured parameter. The tolerance may be, for example, +/−1% to 3%, +/−1% to 5%, or +/−5% to 10% of the target value. In some embodiments, the tolerance or upper and lower limits of the predetermined range may be a critical tolerance of the water treatment system, referring to the outside boundaries of the measured parameter beyond which the water treatment system begins to fail or at least one system component is at capacity or at a safety boundary.

The methods may include providing reference values for the predetermined range, target value and/or tolerance, and optionally critical tolerance, to the local controller via the cloud application. In some embodiments, the methods may include selecting the values for the predetermined range, target value, tolerance, and/or critical tolerance, for example, responsive to an assessment of the water treatment system. In other embodiments, the local controller or cloud-based platform may be programmed to provide a recommendation for the selected values. The reference values for the predetermined range, target value, tolerance, and/or critical tolerance may be stored in the local controller memory storage device or in a memory storage of the cloud-based platform accessible by the local controller.

Responsive to determining that a parameter is outside the predetermined range, the local controller may be programmed to generate a communication to notify a user that the measurement is outside the predetermined range. Thus, the systems and methods may include notifying the user of a parameter status. The systems and methods may include notifying the user by issuing a push notification through the cloud application running on a computer or mobile device of the user, issuing an electronic mail (e-mail) communication to the user, issuing a short message service (SMS) text message communication to the user.

Based on the magnitude of the measurement and degree of separation from the predetermined range, the local controller may generate a communication including a recommendation that the user perform maintenance on the water treatment system. The maintenance may be, for example, an emergency or urgent service, an unexpected service (such as a routine service needed at an unexpected time or a service of an unexpected nature), or a routine service. Thus, the local controller may recommend scheduling or rescheduling a routine service. The local controller may provide a recommended timeline for the maintenance, for example, the local controller may recommend performing the maintenance immediately or within a selected amount of time.

In some embodiments, the local controller may be programmed to generate communications to a user without generating a protocol to instruct the water treatment system to respond to the measurement being outside the predetermined range. For instance, the local controller may lack programmable logic controller (PLC) functionality or be disconnected from any PLC (the water treatment system may lack a local PLC). The local controller may be disconnected from any water treatment unit. Thus, the local controller may generate communications to a user without communicating any treatment or response protocol to a water treatment unit of the system. For example, the local controller, e.g., the treatment module, may generate an alarm without generating a control signal.

In some embodiments, the local controller is a passive controller, not equipped or programmed to take action on any aspect of the water treatment system. In other embodiments, the local controller is a selectively active controller, programmed to take only certain limited actions on aspects of the water treatment system. For example, the local controller may be programmed to stop or halt an aspect of the water treatment system responsive to an indication that a measured parameter is outside a critical tolerance of a target value, without taking any additional action, such as generating a protocol to instruct the water treatment system to respond to the measurement being outside the predetermined range. In such embodiments, the local controller may be connectable or connected to a water treatment unit for the sole purpose of being able to instruct an emergency stop or halt of the water treatment unit. For example, an emergency stop signal may be generated if a pressure of in a subsystem of the water treatment system exceeds a predetermined value.

In other embodiments, the local controller may be an active controller programmed to take action on the water treatment system responsive to the parameter measurements. For instance, the local controller may be programmed to increase or decrease flow rate, dosing rate, hydraulic residence time, or other aspects of the water treatment, responsive to the measured parameters. In such embodiments, the local controller may be connectable or connected to a water treatment unit.

The methods of retrofitting an existing water treatment system may comprise providing a local controller operably connectable to the treatment module and operably connectable to the cloud-based platform. The method may comprise operably connecting the local controller to the treatment module and the cloud-based platform. The local controller may be programmed to determine whether the measurement is outside a predetermined range and generate a communication to notify a user. In some embodiments, the method may comprise programming the local controller or providing one or more value for the predetermined range, target value, tolerance, or critical tolerance to the local controller.

The local controller may be operably connected to a cloud-based platform. The methods of monitoring a water treatment system may comprise transmitting the aggregated signal to the cloud-based platform. In some embodiments, the cloud-based platform may receive and store data from the local controller. For instance, the cloud-based platform may receive and store the aggregated signal or a plurality of input signals decoded from the aggregated signal. The cloud-based platform may store historical data for the measured parameters.

In some embodiments, the cloud-based platform may retrieve concurrent data from a public database. The concurrent data retrieved from a database may include, for example, geographic location, season, predictive environmental data, and others. Exemplary predictive environmental data may include weather predictions regarding one or more of precipitation, outdoor temperature, outdoor relative humidity, wind speed, wind direction, and atmospheric pressure. The data stored on the cloud-based platform may be accessible by a cloud application programmed to run on a computer or mobile device of the user.

In some embodiments, the cloud-based platform may be programmed to determine whether the water treatment system is trending to an alarm state. The cloud-based platform may use artificial intelligence to monitor the system for process anomalies and provide predictive analytics. For instance, responsive to the local controller transmitting a plurality of measurements to the cloud-based platform, optionally in the form of an aggregated signal, the cloud-based platform may determine whether the water treatment system is trending to an alarm state. In some embodiments, the determination may be performed responsive to the cloud-based platform also retrieving concurrent data, such as predictive environmental data and other data.

The alarm state, as disclosed herein, may refer to a state in which the water treatment system may experience one or more failure, for example, the state in which one or more parameter is expected to be outside a critical tolerance of the target value. The failure may be related to acceptable product water quality or other considerations, such as energy consumption, unit operation or water storage volumes, and safe operating standards of system components. The water treatment system may be trending to the alarm state when it is determined that, without manual intervention, there is a high probability that the water treatment system will experience the one or more failure at a future time point.

Thus, in accordance with certain embodiments, the cloud-based platform may provide cloud computing, for example, the cloud-based platform may be programmed to provide predictive analytics. The cloud-based platform may run a transformation function programmed to predict future operation of the water treatment system based on historically collected data and, optionally, on concurrent data retrieved from a public database, such as geographic location, season, time of day, day of week, and predictive environmental data, to calculate predictive signal values which may be used to determine whether the water treatment system is trending to the alarm state.

Determining whether the water treatment system is trending to the alarm state may comprise decoding the aggregated signal to obtain a plurality of signal values and comparing each signal value to at least one respective reference value defining a target range. The target range of the measured parameter may be selected based on ideal or optimized operation of the water treatment system. For instance, the target range may be based on ideal or optimized target product water quality or other considerations, such as target energy consumption, unit operation or water storage volumes, and ideal or optimized target operating standards of system components. The user may select upper and lower limits for the target range. In other embodiments, the user may select a target value for each measured parameter and an acceptable tolerance for the value of the measured parameter corresponding with the target range. The reference values for the target range or target value and tolerance may refer to the outside boundaries of the measured parameter beyond which the water treatment system begins to lose efficiency or operate beyond optimized parameters.

If at least one signal value is outside the target range, the methods may comprise providing the plurality of signal values to a transformation function trained with historical data. A calculation may be performed on the transformation function using the plurality of signal values to obtain a plurality of predictive signal values. The predictive signal values may refer to predicted measurements for future operation of the water treatment system, given the historical operation of the system. These predictive signal values may be compared to at least one respective reference value defining the predetermined range to determine whether any predictive signal value is outside the predetermined range. The water treatment system may be identified as trending to an alarm state if at least one predictive signal value is outside the predetermined range. Optionally, the water treatment system may be identified as trending to an alarm state if at least one predictive signal value is outside a critical tolerance of the target value.

The methods may comprise providing the plurality of signal values and concurrent data to the transformation function to obtain the plurality of predictive signal values. Thus, in some embodiments, the methods may comprise performing the calculation on the transformation function using the plurality of signal values and also concurrent data retrieved from the public database, such as the geographic location, season, time of day, day of week, and predictive environmental data. Thus, the transformation function may calculate the plurality of predictive values considering current measurements, historical operation, and geographic location, season, time of day, day of week, and predicted weather patterns.

Additionally, in certain embodiments, the predictive signal value may be calculated based on a selected future timepoint. For instance, the predictive signal value, referring to predicted measurements for future operation, may be calculated for one or more future timepoint selected from, for example, one hour, 12 hours, 24 hours, 48 hours, 72 hours, 5 days, 7 days, 10 days, 15 days, 30 days, 2 months, 6 months, 12 months, or more. In some embodiments, the predictive signal value may be continuously, e.g., iteratively, calculated until a predicted alarm state is identified. The expected timepoint for the predicted alarm state may also be identified. In other embodiments, the method may comprise selecting the future timepoint and providing the future timepoint to the cloud-based platform, for example, via the cloud application, to determine whether an alarm state is predicted at the selected timepoint.

Upon determining that the water treatment system is trending to an alarm state, the cloud application may be programmed to generate a communication to notify a user that the water treatment system is trending to the alarm state. The cloud application may notify the user by issuing a push notification through the cloud application running on a computer or mobile device of the user, issuing an electronic mail (e-mail) communication to the user, issuing a short message service (SMS) text message communication to the user, or other communication.

Based on the probability and magnitude of the predicted failure, the cloud application may generate a communication including a recommendation that the user perform maintenance on the water treatment system, as previously described. The maintenance may be, for example, an emergency or urgent service, an unexpected service (such as a routine service needed at an unexpected time or a service of an unexpected nature), or a routine service. The cloud application may recommend scheduling or re-scheduling a routine service. The cloud application may indicate which parameter is expected to be outside the predetermined range. Furthermore, in some embodiments, the cloud application may indicate which system component may require service to prevent the parameter from being outside the predetermined range in the future. The cloud application may provide a probability for the failure and recommended timeline for the maintenance, for example, the cloud application may recommend performing the maintenance immediately or within a selected amount of time. In some embodiments, the cloud application may recommend performing the maintenance if the probability of failure in the future is greater than 50%, for example, greater than 60%, 70%, 80%, 90%, 95%, 99%, or is 100%. Probability may be determined adjusted based on historical trends.

The methods may comprise providing the at least one reference value defining the target range, target value, or tolerance to the cloud-based platform and providing the at least one reference value defining the predetermined range, target value, tolerance, or critical tolerance to the cloud-based platform. The reference values may be provided to the cloud-based platform via the cloud application. In some embodiments, the methods may include selecting the values for the target range and/or predetermined range (including upper and lower limits, and/or target value and tolerance), for example, responsive to an assessment of the water treatment system. In other embodiments, cloud-based platform may be programmed to provide a recommendation for the selected values. The reference values for the target range and predetermined range (including upper and lower limits, and/or target value and tolerance) may be stored in the memory storage of the cloud-based platform.

One exemplary cloud application is the Link2Site® Remote Monitoring System (operated by Evoqua Water Technologies LLC, Pittsburgh, PA). The Link2Site® system is a cellular based monitoring and control solution. Link2Site® monitoring system utilizes national coverage of the cellular network to provide a reliable and secure monitoring and control system. The Link2Site® system may operate as a remote monitoring platform, as well as generate e-mail and text alarm conditions to immediately alert users of non-compliant conditions at the selected water treatment points. The Link2Site® system may be password protected and accessible on any web enabled device, allowing application site data to be securely accessed anywhere at any time.

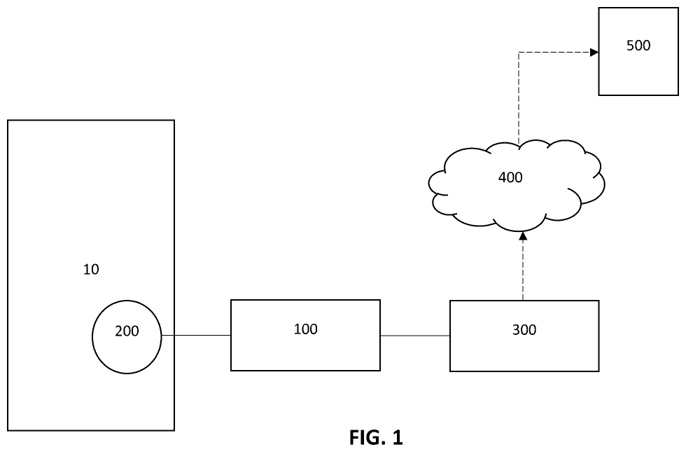

FIG. 1 is a box diagram of a remote monitoring system according to one embodiment. The remote monitoring system includes at least one sensor 200 operably connected to a treatment module 100, which is operably connected to a local controller 300, which is operably connected to a cloud-based platform 400, which is operably connected to the user's computing or mobile device 500 running the cloud application. Through the remote monitoring system of FIG. 1, a user may remotely monitor parameters from an existing water treatment system 10, for example, from existing sensors 200 or new sensors 200 positioned to measure a parameter of the water treatment system. Treatment module 100 may be positioned proximate to sensor 200 at or near a treatment subsystem. Local controller 300 may be positioned at or near the water treatment system, for example, in a control center of the water treatment system.

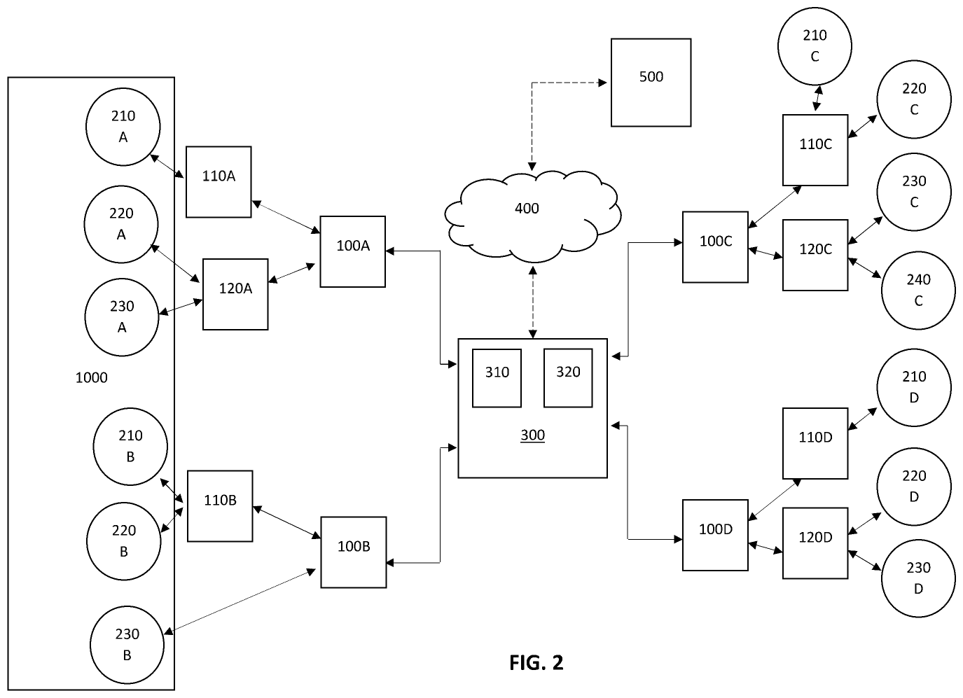

FIG. 2 is a box diagram of a remote monitoring system, according to another embodiment. The system of FIG. 2 is similar to the system of FIG. 1, but includes a plurality of treatment modules, identified as a plurality of input modules 110A, 110B, 110C, 110D, 120A, 120C, and 120D and data aggregators 100A, 100B, 100C, and 100D, operably connected to the local controller 300 and plurality of sensors 210A, 220A, 230A, 210B, 220B, 230B, 210C, 220C, 230C, 240C, 210D, 220D, and 230D, each connected to and monitoring a parameter of water treatment system 1000. As shown in the system of FIG. 2, sensors (e.g., 210B, 220B) may be connected to input modules (e.g., 110B) or sensors (230B) may be directly operably connected to a data aggregator (100B). The local controller 300 may include a processor 310 and data storage device 320. Local controller 300 is operably connected to cloud-based platform 400 and a computing or mobile device 500 of the user running the cloud application.

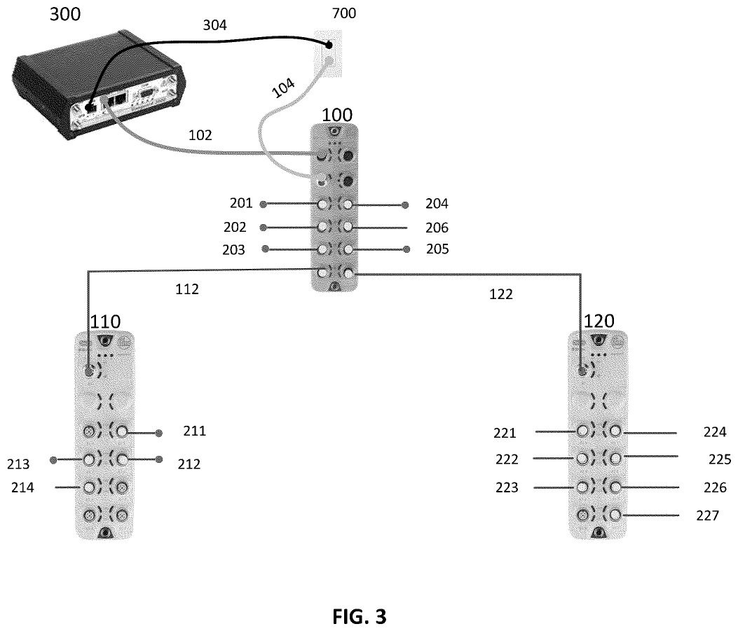

FIG. 3 is a schematic diagram of a system for monitoring a water treatment system. The system of FIG. 3 includes two input signal modules 110, 120, each connected to a plurality of sensors 211, 212, 213, 214, 221, 222, 223, 224, 225, 226, 227 through female/male connectors. The exemplary input signal modules 110, 120 comprise a plurality of female wireable connections. The exemplary sensors of FIG. 3 include a city water inlet pressure sensor (211), a post-filter pressure sensor (212), an RO inlet pressure sensor (213), an RO outlet conductivity signet (214), a loop resistivity meter (221), a loop temperature sensor (222), a tank level sensor (223), a worker resistivity meter (224), a polisher resistivity meter (225), a distribution flow meter (226), and a digital relay output (227).

Both signal modules 110, 120 are connected to a data aggregator 100 by connectors 112, 122, respectively. In the exemplary embodiment of FIG. 3, each signal module 110, 120 includes a male connection for connectors 112, 122. Additional sensors RO outlet flow meter (201), RO inlet flow meter (202), RO inlet conductivity meter (203), RO outlet pressure meter (204), and city water inlet flow meter (205) are connected to data aggregator 100. A push button 206 is also connected to data aggregator 100 to activate/deactivate the data aggregator 100. The data aggregator 100 is connected to a local controller FLEX modem 300 via ethernet connection 102 and to a power source 700 via power adapter 104. The local controller FLEX modem 300 is also connected to power source 700 via power adapter 304 and connectable to a cellular network. Each of the signal modules 110, 120, data aggregator 100, and FLEX modem 300 are contained in a housing (not shown).

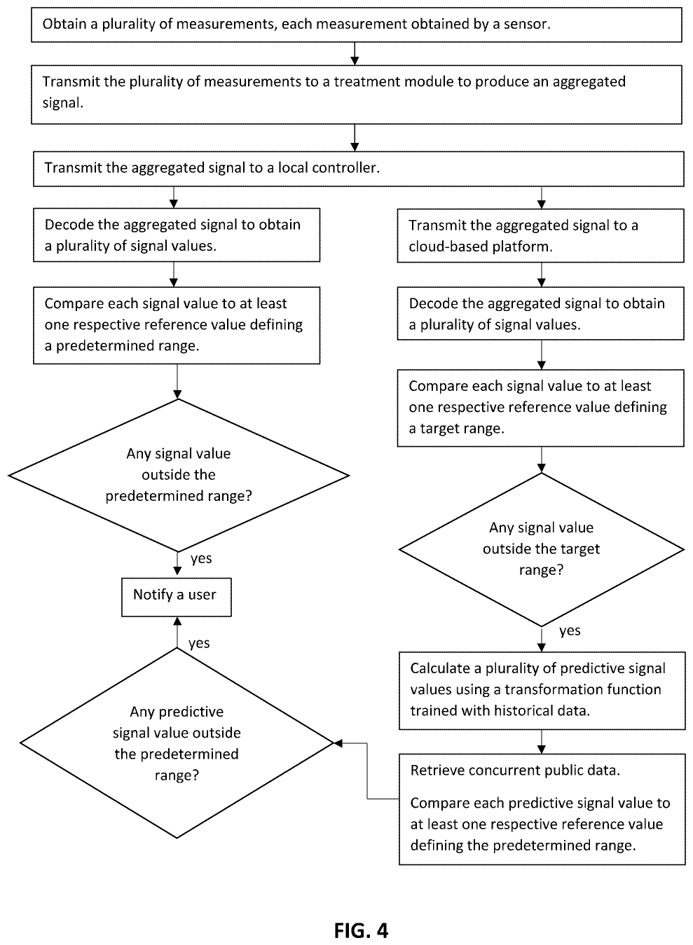

FIG. 4 is a flow diagram of a method for monitoring a water treatment system. As shown in the flow diagram of FIG. 4, the method may include obtaining a plurality of measurements, each measurement obtained by a sensor. The method may include transmitting the plurality of measurements to a treatment module to produce an aggregated signal. The method may include transmitting the aggregated signal to a local controller. The method may include transmitting the aggregated signal to a cloud-based platform. The method may include decoding the aggregated signal to obtain a plurality of signal values.

In some embodiments, the method may include comparing each signal value to at least one respective reference value defining a predetermined range. If any signal value is outside a predetermined range, the method may include notifying a user. Noise or false positives may be reduced by implementing a time delay to confirm the signal value remains within the predetermined range for a predetermined period.

In some embodiments, the method may include comparing each signal value to at least one respective reference value defining a target range. If any signal value is outside the target range, the method may include calculating a plurality of predictive signal value using a transformation function trained with historical data. In some embodiments, the method may include retrieving concurrent data from the public and comparing each predictive signal value to at least one respective reference value defining the predetermined range. If any predictive signal value is outside the predetermined range, the method may include notifying the user.

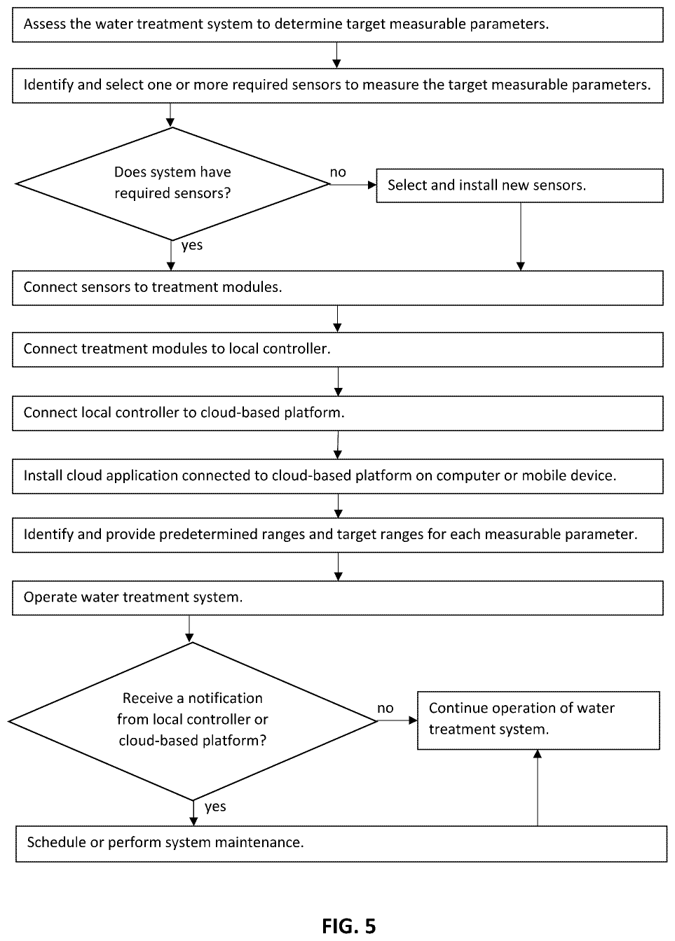

FIG. 5 is a flow diagram of a method for retrofitting a water treatment system. As shown in the flow diagram of FIG. 5, the method may include assessing the water treatment system to determine target measurable parameters. The target measurable parameters may be selected responsive to a desired purpose, process value, and/or risk impact of the system or subsystem. The method may include identifying and selecting one or more required sensors to measure the target measurable parameters. In some embodiments, if the system does not have the required sensors, the method may include selecting and installing new sensors and connecting the sensors to treatment modules. In some embodiments, if the system does have the required sensors, the method may include connecting the sensors to treatment modules. In other embodiments, at least some existing sensors may be connected to treatment modules and at least some new sensors may be selected, installed, and connected to the treatment modules.

The methods may include connecting the treatment modules to a local controller. The methods may include connecting the local controller to a cloud-based platform. The methods may include installing a cloud application connected to the cloud-based platform on a computer or mobile device of the user. The methods may include identifying and providing predetermined ranges and target ranges (including, for example, upper and lower limits, target values, and/or tolerance values) for each measurable parameter, for example, via the cloud application. In some embodiments, if the user receives a notification from the local controller or cloud-based platform, for example, that a parameter is outside the predetermined range or the water treatment system is trending to an alarm state, the method may include scheduling or performing a system maintenance and then continuing operation of the water treatment system. Otherwise, if no notification is received, the method may include continuing operation of the water treatment system.

By utilizing the above-described system, existing water treatment equipment may be transformed into a “smart” system capable of providing various insights and functionality such as, e.g., edge alarming, parameter totalizations and averages (e.g., daily water consumption totalization or average daily water consumption totalization), predictive analytics, and others. Such intelligence may increase system operating time (reducing maintenance time), reliability, provide robust scale-up design, and impact sustainability objectives. Additionally, the system described herein may decrease the complexity of an installation by eliminating the need for a programmable logic controller (PLC), leveraging smart sensors and clamp-on flow meters. The system may also provide edge intelligence, increasing the onsite value of the monitoring solution. In some embodiments, the system may leverage AI for predictive analytics, reducing onsite service requirements. In some embodiments, the system may leverage edge AI for predictive analytics around, for example, service deionization (SDI) service exchanges, and other system-specific routine maintenance procedures.

The function of these and other embodiments can be better understood from the following example. The example is intended to be illustrative in nature and not considered to be limiting the scope of the invention.

### Example: Remote Monitoring System Design for Municipal Water

An existing municipal water treatment system was assessed for retrofitting with a remote monitoring system, as disclosed herein. Several subsystems were identified for treatment modules, including pre-treatment (city water), polishing (reverse osmosis and deionized water system), and distribution (storage and distribution loop). Desired purpose, process value, and risk impact were identified for each subsystem. Responsive to the desired purpose, process value, and risk impact, several parameters were selected at each subsystem, including flow totalization, pressure, conductivity, resistivity, temperature, tank level, and UV intensity. Existing and new sensors were identified to measure each parameter at each subsystem. A summary of the designed remote monitoring system is presented in Table 1.

Accordingly, a remote monitoring system may be designed to achieve a desired purpose, process value, and risk impact for an existing water treatment system. The system may be retrofit by identifying measurable parameters for one or more subsystem and selecting existing or new sensors capable of measuring the parameters. New sensors may be installed, existing and new sensors may be connected to a treatment module, local controller, and cloud-based platform for remote monitoring of the system.

TABLE 1
Remote Monitoring System Design

| Monitoring | | | | Process | Risk | Measurable | | Alarm |
|---|---|---|---|---|---|---|---|---|
| Point | Sensor | Units | Purpose | Value | Impact | values | Report values | events |
| City water | Flow | gpm | Capture total | Establish | Sustainability; | City | City water | System |
| flow | meter - | | gallons used by | water use | Total | water | monthly total | recovery |
| totalization | New | | the legacy | patterns; | cost of | daily | (gallons); | low; |
| | | | system | Identify future | ownership | total | City water | System |
| | | | | use | | (gallons); | daily average | recovery |
| | | | | anomalies; | | City | (gallons); | high |
| | | | | Calculate total | | water | City water | |
| | | | | system | | flowrate | monthly | |
| | | | | recovery | | (gpm); | average | |
| | | | | | | System | (gallons) | |
| | | | | | | recovery | System | |
| | | | | | | (%) | recovery daily | |
| | | | | | | | average (%); | |
| | | | | | | | System | |
| | | | | | | | recovery | |
| | | | | | | | monthly | |
| | | | | | | | average (%) | |
| City water | Pressure | psi | Track changes in | Detect over | Quantity; | Pre- | Average daily | High |
| pressure | meter - | | city water | pressure | Total | treatment | pre-treatment | city |
| | New | | pressure; | events; | Cost of | water | inlet water | water |
| | | | Troubleshoot | Detect system | Ownership | pressure | pressure (psig) | pressure; |
| | | | system related | plugging | | (psig); | | Low city |
| | | | issues | issues | | | | water |
| | | | | | | | | pressure |
| Post pre- | Pressure | psi | Monitor the city | Detect system | Quantity; | post | Post treatment | Pre- |
| treatment | meter - | | water pressure | plugging | Total | treatment | daily average | treatment |
| pressure | New | | after softening, | | cost of | water | water pressure | pressure |
| | | | carbon and | | ownership | pressure | | differential |
| | | | filters. | | | (psig); | | (delta P) |
| | | | | | | Pre- | | high; |
| | | | | | | treatment | | Final |
| | | | | | | pressure | | pre- |
| | | | | | | differential | | treatment |
| | | | | | | (delta P) | | pressure |
| | | | | | | (psig) | | low |
| RO | Flow | gpm | Capture the total | Calculate RO | Quantity; | RO | RO daily | RO |
| feedwater | meter - | | gallons used for | recovery (%); | Sustainability; | feedwater | average | recovery |
| flow | New | | make-up water | Determine RO | Resiliency; | flow | recovery (%); | low; |
| totalization | | | to the RO unit; | run hours; | Total | rate | RO daily | RO |
| | | | Capture when | Determine | cost of | (gpm); | average run | recovery |
| | | | the RO is | cycle | ownership | RO | time (hours); | high |
| | | | running and for | frequency | | feedwater | RO daily | |
| | | | how long (total | | | daily | average cycle | |
| | | | or daily run | | | total | time (hours) | |
| | | | time) | | | (gallons); | | |
| | | | | | | RO | | |
| | | | | | | recovery | | |
| | | | | | | (%); | | |
| | | | | | | RO | | |
| | | | | | | pump | | |
| | | | | | | status | | |
| | | | | | | (ON/OFF) | | |
| RO | Conductivity | mmhos | Capture the | RO rejection | Quality; | RO | RO feedwater | RO |
| feedwater | meter - | | conductivity of | (%); | Quantity; | feedwater | daily average | feedwater |
| conductivity | New | | the feedwater to | Monitor | Total | conductivity | conductivity | conductivity |
| | | | the RO, post | changes in RO | cost of | (mmhos); | RO feedwater | high; |
| | | | pre-treatment; | make-up | ownership | RO | daily average | RO |
| | | | Capture the | conductivity | | feedwater | temperature; | feedwater |
| | | | feedwater | Monitor | | temperature | RO feedwater | temperature |
| | | | temperature | changes to | | (° F./° C.) | monthly | high; |
| | | | | feedwater | | | average | RO |
| | | | | temperature | | | conductivity | feedwater |
| | | | | and impact on | | | RO feedwater | temperature |
| | | | | RO | | | monthly | low |
| | | | | performance | | | average | |
| | | | | | | | temperature | |
| RO | Pressure | psig | Capture the | RO pressure | Quantity; | RO | RO daily | RO |
| booster | sensor - | | booster pump | drop and | Resiliency; | booster | average | booster |
| pump | New | | discharge water | performance | Total | pump | booster pump | pump |
| pressure | | | pressure | | cost of | discharge | pressure | pressure |
| | | | Determine when | | ownership | pressure | | high; |
| | | | the RO is | | | (psig) | | RO |
| | | | running | | | | | booster |
| | | | | | | | | pump |
| | | | | | | | | pressure |
| | | | | | | | | low |
| RO | Flow | gpm | Capture the total | RO total | Quantity; | RO | RO daily | RO |
| permeate | meter - | | permeate | permeate | Sustainability; | permeate | average | permeate |
| flow | New | | production | production; | Resiliency; | flowrate | permeate | flow |
| totalization | | | | RO percent | Total | (gpm); | (gallons); | low; |
| | | | | recovery | cost of | RO | RO monthly | RO |
| | | | | calculation; | ownership | permeate | average | permeate |
| | | | | System total | | daily | permeate | flow |
| | | | | recovery | | total | (gallons) | high |
| | | | | | | flow | | |
| | | | | | | (gallons) | | |
| RO | Conductivity | mmhos | Capture the | RO permeate | Quantity; | RO | RO permeate | RO |
| permeate | meter - | | permeate | conductivity | Sustainability; | permeate | daily average | permeate |
| conductivity | New | | conductivity | Estimated SDI | Total | conductivity | conductivity | conductivity |
| | | | | days until | cost of | (mmhos); | RO permeate | high; |
| | | | | exhaustion; | ownership | RO | monthly | RO |
| | | | | RO rejection | | rejection | average | permeate |
| | | | | (%) | | (%) | conductivity | rejection |
| | | | | | | | RO rejection | low |
| | | | | | | | daily average | |
| | | | | | | | (%); | |
| | | | | | | | RO rejection | |
| | | | | | | | monthly | |
| | | | | | | | average (%) | |
| RO | Pressure | psig | Capture the | RO permeate | Quantity; | RO | RO permeate | RO |
| permeate | sensor - | | permeate | pressure; | Sustainability; | permeate | pressure; | permeate |
| pressure | New | | pressure | RO pressure | Resiliency; | pressure | RO permeate | pressure |
| | | | | differential | Total | (psig); | pressure daily | high; |
| | | | | (delta P); | cost of | RO | average; | RO |
| | | | | Membrane | ownership | pressure | RO permeate | permeate |
| | | | | performance | | differential | pressure | pressure |
| | | | | | | (delta P) | monthly | low |
| | | | | | | (psig) | average | RO |
| | | | | | | | | pressure |
| | | | | | | | | differential |
| | | | | | | | | (delta P) |
| | | | | | | | | high |
| DI worker | Resistivity | mmhos | Capture the DI | DI worker | Quality; | Meter | Dates | DI |
| resistivity | meter - | | performance | resistivity and | Resilience; | reading; | exchanges | worker |
| | existing | | over time; | performance | Total | Current | performed; | resistivity |
| | | | Determine when | | cost of | month; | Average | low; |
| | | | the quality | | ownership | Previous | number of days | Remaining |
| | | | requires an | | | month; | between | capacity; |
| | | | exchange | | | Remaining | exchanges; | System |
| | | | | | | capacity | Worker daily | exhausted |
| | | | | | | (%); | average | |
| | | | | | | Current | resistivity | |
| | | | | | | tank | | |
| | | | | | | capacity | | |
| | | | | | | (grains); | | |
| | | | | | | Total | | |
| | | | | | | tank | | |
| | | | | | | capacity | | |
| | | | | | | (grains) | | |
| | | | | | | Worker | | |
| | | | | | | alarm; | | |
| | | | | | | Feed | | |
| | | | | | | resistivity | | |
| | | | | | | (mmhos); | | |
| | | | | | | Worker | | |
| | | | | | | resistivity | | |
| | | | | | | (Mohm); | | |
| | | | | | | Flow | | |
| | | | | | | total | | |
| | | | | | | this | | |
| | | | | | | exchange | | |
| | | | | | | (gallons); | | |
| | | | | | | Previous | | |
| | | | | | | exchange | | |
| | | | | | | flow | | |
| | | | | | | total | | |
| | | | | | | (gallons); | | |
| | | | | | | Project | | |
| | | | | | | days | | |
| | | | | | | remaining | | |
| DI | Resistivity | mmhos | Capture the DI | DI polisher | Quality; | Polisher | SDI daily | Polisher |
| polisher | meter - | | performance | resistivity and | Resilience; | resistivity | average | resistivity |
| resistivity | existing | | over time; | performance | Total | (mmhos); | (gallons); | low |
| | | | Determine when | | cost of | SDI | SDI monthly | |
| | | | the quality | | ownership | daily | total (gallons) | |
| | | | requires an | | | total | Polisher daily | |
| | | | exchange | | | (gallons); | average | |
| | | | | | | SDI | resistivity | |
| | | | | | | previous | (mmhos) | |
| | | | | | | daily | | |
| | | | | | | total | | |
| | | | | | | (gallons) | | |
| Storage | Level | % | Measure the | Tank level | Quality; | Tank | None | Storage |
| tank level | sensor | | actual volume in | being | Resilience; | level | | tank |
| | (analog) - | | the storage tank; | maintained | Total | (%) | | high; |
| | existing | | Determine when | (%) | cost of | | | Storage |
| | | | the tank reaches | | ownership | | | tank |
| | | | critical levels; | | | | | high- |
| | | | Monitor | | | | | high |
| | | | production use | | | | | (critical); |
| | | | over time | | | | | Storage |
| | | | | | | | | tank |
| | | | | | | | | low; |
| | | | | | | | | Storage |
| | | | | | | | | tank |
| | | | | | | | | low-low |
| | | | | | | | | (critical) |
| Distribution | UV light | N/A | Monitor UV | Verify UV | Quality; | UV | Date of last | UV |
| loop UV | meter - | | intensity; | intensity is | Resilience; | intensity | UV bulb | intensity |
| intensity | existing | | Determine if UV | above the | Total | | exchange | within |
| | | | intensity drops | setpoint | cost of | | service | range |
| | | | below the | | ownership | | | |
| | | | setpoint | | | | | |
| Distribution | Flow | gpm | Monitor the loop | flowrate over | Quantity; | Loop | Average | Distribution |
| loop | meter - | | flowrate; | time (gpm) | Quality; | flowrate | flowrate over | loop |
| flowrate | Existing | | Ensure the | | Resilience; | (gpm) | time | flowrate |
| | | | distribution is | | Total | | | low; |
| | | | running; | | cost of | | | Distribution |
| | | | Ensure flowrate | | ownership | | | loop |
| | | | is optimal for | | | | | flowrate |
| | | | biological | | | | | high |
| | | | control | | | | | |
| Distribution | Temperature | ° F./ | Monitor instant | Instant | Quality; | Loop | Loop daily | Distribution |
| loop | sensor - | ° C. | loop | temperature | Resilience; | temperature | average | loop |
| temperature | Existing | | temperature; | | Total | (° F./° C.) | temperature | temperature |
| | | | Monitor trends | | cost of | | | low; |
| | | | in the loop over | | ownership | | | Distribution |
| | | | time; | | | | | loop |
| | | | Ensure optimal | | | | | temperature |
| | | | temperature | | | | | high; |
| | | | maintained for | | | | | Distribution |
| | | | water quality; | | | | | loop |
| | | | Monitor | | | | | temperature |
| | | | sanitization | | | | | critical |
| | | | performance | | | | | (high- |
| | | | | | | | | high) |
| Distribution | Conductivity | mmhos | Instant loop | Instant | Quality; | Loop | Loop daily | Distribution |
| loop | meter - | | conductivity; | conductivity | Resilience; | conductivity | average | loop |
| conductivity | Existing | | Monitor | | Total | (mmhos) | conductivity | conductivity |
| | | | trending loop | | cost of | | | high; |
| | | | conductivity | | ownership | | | Distribution |
| | | | over time | | | | | loop |
| | | | | | | | | conductivity |
| | | | | | | | | critical |
| | | | | | | | | (high- |
| | | | | | | | | high) |

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A method of monitoring a water treatment system, the method comprising:
obtaining at least one measurement, each measurement obtained from a respective sensor positioned to measure a respective parameter of the water treatment system;
transmitting each of the at least one measurement to a treatment module, the treatment module configured to produce an aggregated signal;
transmitting the aggregated signal to a local controller, the local controller configured to determine whether any measurement is outside a predetermined range;
responsive to at least one measurement being outside the predetermined range, generating a first communication to notify a user that at least one measurement is outside the predetermined range; and
transmitting the aggregated signal to a cloud-based platform.

2. The method of claim 1, wherein determining whether any measurement is outside the predetermined range comprises decoding the aggregated signal to obtain a plurality of signal values and comparing each signal value to at least one respective reference value defining the predetermined range.

3. The method of claim 2, further comprising responsive to the at least one measurement being outside the predetermined range, generating in the first communication a recommendation to perform maintenance on the water treatment system.

4. The method of claim 2, further comprising providing the at least one reference value defining the predetermined range to the local controller.

5. The method of claim 1, comprising transmitting the aggregated signal to the cloud-based platform to determine whether the water treatment system is trending to an alarm state and generating a second communication to notify the user that the water treatment system is trending to the alarm state.

6. The method of claim 5, wherein determining whether the water treatment system is trending to the alarm state comprises decoding the aggregated signal to obtain a plurality of signal values, comparing each signal value to at least one respective reference value defining a target range;
if at least one signal value is outside the target range, providing the plurality of signal values to a transformation function trained with historical data and performing a calculation on the transformation function to obtain a plurality of predictive signal values; and
comparing the plurality of predictive signal values to at least one respective reference value defining the predetermined range to determine whether any predictive signal value is outside the predetermined range;
wherein the water treatment system is trending to an alarm state if at least one predictive signal value is outside the predetermined range.

7. The method of claim 6, wherein the water treatment system is trending to an alarm state if only one predictive value is outside the predetermined range.

8. The method of claim 6, comprising providing the plurality of signal values and concurrent data to the transformation function to obtain the plurality of predictive signal values.

9. The method of claim 6, comprising providing the at least one reference value defining the target range to the cloud-based platform, and providing the at least one reference value defining the predetermined range to the cloud-based platform.

10. The method of claim 6, further comprising responsive to determining that the water treatment system is trending to the alarm state, generating in the second communication a recommendation to perform maintenance on the water treatment system.

11. A method of retrofitting a water treatment system, the method comprising:
providing a treatment module operably connectable to at least one sensor positioned to measure a parameter of the water treatment system;
operably connecting the treatment module to the at least one sensor;
providing a local controller operably connectable to the treatment module and operably connectable to a cloud-based platform; and
operably connecting the local controller to the treatment module and the cloud-based platform.

12. The method of claim 11, wherein, responsive to the local controller receiving the measurement of the parameter, the local controller is programmed to determine whether the measurement is outside a predetermined range and generate a first communication to notify a user that the measurement is outside the predetermined range.

13. The method of claim 12, further comprising providing one or more value for the predetermined range to the local controller.

14. The method of claim 12, further comprising assessing the water treatment system to determine target measurable parameters and selecting the at least one sensor.

15. The method of claim 11, wherein the treatment module is operably connectable to a plurality of sensors, each sensor configured to measure a respective parameter of the water treatment system, the method comprising operably connecting the treatment module to each sensor.

16. The method of claim 15, comprising providing more than one treatment module selected from a pretreatment module, a processing module, a polishing module, and a distribution module, the method further comprising operably connecting each treatment module to a respective plurality of sensors.

17. The method of claim 15, wherein responsive to the local controller transmitting a plurality of measurements, each measurement of a respective parameter, to a cloud application via the cloud-based platform, the cloud application is programmed to determine whether the water treatment system is trending to an alarm state and generate a second communication to notify a user that the water treatment system is trending to the alarm state.

18. The method of claim 17, further comprising providing one or more value for a plurality of predetermined ranges to the cloud application, each predetermined range associated with a respective measurement.

19. The method of claim 11, further comprising providing the at least one sensor.

20. The method of claim 19, further comprising installing the at least one sensor within the water treatment system.

21. A system for monitoring a water treatment system, comprising:
at least one sensor positioned to measure a parameter of the water treatment system;
a treatment module operably connected to the at least one sensor; and
a local controller operably connected to the treatment module and operably connectable to a cloud-based platform, the local controller programmed to determine whether a measurement of the parameter is outside a predetermined range and generate a first communication to notify a user that the measurement is outside the predetermined range, without generating a protocol to instruct the water treatment system to respond to the measurement being outside the predetermined range.

22. The system of claim 21, comprising a plurality of sensors operably connected to the treatment module, each sensor configured to measure a respective parameter of the water treatment system.

23. The system of claim 22, wherein each sensor is selected from a flow meter, pressure meter, conductivity meter, resistivity meter, temperature sensor, composition sensor, pH meter, light meter, and a tank level sensor.

24. The system of claim 22, comprising a plurality of treatment modules selected from a pretreatment module, a processing module, a polishing module, and a distribution module.

25. The system of claim 22, wherein the treatment module comprises at least one input signal module operably connected to the plurality of sensors and a data aggregator operably connected to the at least one input signal module and the local controller.

26. The system of claim 25, wherein the data aggregator is programmed to receive a plurality of input signals from the input signal module, each input signal comprising a respective measurement of each parameter, the data aggregator further being programmed to produce an aggregated signal from the plurality of input signals and transmit the aggregated signal to the local controller.

27. The system of claim 21, wherein the at least one sensor is configured to transmit a digital signal to the input signal module.

28. The system of claim 21, wherein the at least one sensor is configured to transmit an analog signal to the input signal module.
